(19) United States
(12) Patent Application Publication
(10) Pub. No.: US 2009/0229216 A1
(43) Pub. Date: Sep. 17, 2009

(54) Impact resistant multipane window

(75) Inventors: Craig B. Duncan, Trinity, FL (US); Henry M. Hay, III, Charleston, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: Muhler Laminated Glass, Inc., North Charleston, SC (US)

(21) Appl. No.: 12/077,113

(22) Filed: Mar. 17, 2008

(51) Int. Cl. E06B 3/263

(52) U.S. Cl. 52/745.2; 52/204.6

(57) ABSTRACT

A novel method of making a double glazed impact resistant window is provided. The method includes forming a window sash that delineates a mounting space for mounting a first pane and a second pane opposite and parallel to and spaced apart from each other, the sash having an integral spacer that forms a sealing surface of the mounting space for each pane and adhering or coating at least two layers of a durable transparent polymer film to a surface of the first pane such that the at least two layers are not adhered or coated in directions that are parallel to one another. The method further includes conforming the pane to the size and shape of the mounting space, mounting the first pane in the mounting space with the film covered surface of the pane facing the sealing surface of the integral spacer, conforming the second pane to the size and shape of the mounting space, wherein the second pane is free of the durable transparent polymer film, and mounting the second pane in the mounting space.

### BACKGROUND OF THE INVENTION

The present invention relates to multipane insulating windows, and more particularly to multipane insulating windows that are impact resistant.

Windows and glass panes in doors, panels and the like are a major source of unwanted heat loss and gain in a structure. With increased cost of fuel and energy, the moderation of unwanted energy losses on account of these structures has become of increasing importance.

One method of reducing heat transfer through windows has been through the use of double glazed, and even triple glazed windows. Double glazed windows make use of two panes of glass that are attached together by a spacer, such as illustrated in FIG. 2, and shown in U.S. Pat. Nos. 2,756,467, 3,128,509, 3,212,179 and 3,932,971, among others, to provide two panes separated by an enclosed gas space. In some instances, the space between the two panes is hermetically sealed and can be filled with dry air, or with a dry inert gas such as argon or nitrogen.

Although double glazing successfully reduces the energy transfer through a window, the use of two panes of glass substantially increases the weight of the window. Increased weight in windows is normally unwanted because of the need for heavier frames and sashes, heavier mounting hardware, and more rigid sash materials. Moreover, construction of double glazed windows is more complex than normal window construction, because the double glazed pane unit is constructed separately from the sash unit and then the sealed double glazed pane unit is mounted into the sash to assemble the insulated window.

An alternative to the normal method of assembling a double glazed window makes use of a sash unit that has the spacer for the glazing panes formed integrally with the sash. This innovation avoids the separate construction of the sealed double glazed pane unit, because the panes are simply mounted into a sash that has been formed from sash elements that include the integral spacer. This type of construction is illustrated in U.S. Pat. Nos. 6,286,288, 6,563,182, 6,662,523, 6,679,013, 6,823,643, 6,928,776, and 6,974,518, and in U.S. Patent Application Publication Nos. 2005/0132662 A1 and 2006/0218875 A1.

During the past several years, it has also become important to provide windows that are impact resistant. Many building codes, especially in areas that are at risk for hurricanes and major storms, now require impact resistant windows. In addition, blast resistance and shatter resistance has come to be important for windows in selected locations. A conventional method for the provision of impact and shatter resistance for windows has been the construction of safety glass, such as illustrated in FIG. 1 and described in U.S. Pat. No. 3,823,060, among others. In this method of construction, a layer of durable transparent polymer, such as a polyurethane is inserted between and adhered to two panes of glass to make a layered structure having glass on the outside and the polymer on the inside. When the window absorbs a blow that is powerful enough to break the glass, the presence of the durable polymer prevents pieces of glass from detaching from the pane and flying in the direction of travel of the blow. Aspects of this type of construction are also described in U.S. Pat. Nos. 3,620,905, 3,764,457, 3,931,113, and 7,204,901.

Although the method described above has proven very useful for the manufacture of safety glass, the products are unavoidably heavier than normal glass due to the inclusion of two glass panes. Also, the construction of the glass requires the step of forming the glass/polymer/glass laminate, which demands careful controls and very clean glass surfaces.

In many circumstances, it would be useful to have an insulating window that is also impact resistant. Various alternatives have been used to achieve this combination and the conventional method has been to build a conventional double glazed window unit in which one of the panes is safety glass such as illustrated in FIG. 3. A variation of this is shown in U.S. Patent Publication No. 2005/0126091. However, due to the use of three separate panes of glass, this type of construction results in a very heavy window that requires a number of fabrication steps and requires careful controls during manufacture.

An alternative to the use of three glass panes is shown in U.S. Pat. No. 6,546,692 to Duncan et al., which describes the formation of a normal double glazed window pane unit except that the interior surface of each of the two panes is coated with a film of a transparent durable polymer such as polyethylene terephthalate, polycarbonate, or other like material. The two panes, each having a film coating, are then assembled into a double glazed unit by sealing each pane to a spacer. The double glazing unit can then be mounted into a sash to provide an impact resistant double glazed window. While this type of window avoids the use of three panes of glass, assembly still requires separate construction of the sash and the double glazing unit.

### SUMMARY OF THE INVENTION

Briefly, therefore the present invention is directed to a novel method of making a double glazed impact resistant window. The method includes forming a window sash that delineates a mounting space for mounting a first pane and a second pane opposite and parallel to and spaced apart from each other, the sash having an integral spacer that forms a sealing surface of the mounting space for each pane and adhering or coating at least two layers of a durable transparent polymer film to a surface of the first pane such that the at least two layers are not adhered or coated in directions that are parallel to one another. The method further includes conforming the pane to the size and shape of the mounting space, mounting the first pane in the mounting space with the film covered surface of the pane facing the sealing surface of the integral spacer, conforming the second pane to the size and shape of the mounting space, wherein the second pane is free of the durable transparent polymer film, and mounting the second pane in the mounting space.

The present invention is also directed to a novel method of making a double glazed impact resistant window. The method includes: forming a window sash that delineates a mounting space for mounting a first pane and a second pane opposite and parallel to and spaced apart from each other, the sash having an integral spacer that forms a sealing surface of the mounting space for each pane and adhering or coating at least two layers of a durable transparent polymer film to a surface of the first pane such that the at least two layers are not adhered or coated in directions that are parallel to one another. The method further includes conforming the first pane to the size and shape of the mounting space, trimming the durable transparent polymer film and mounting the first pane in the mounting space with the film covered surface of the pane facing the sealing surface of the integral spacer. Additionally, the method includes conforming the second pane to the size and shape of the mounting space, wherein the second pane is free of the durable transparent film, and mounting the second pane in the mounting space.

The present invention is also directed to an insulating multipane impact resistant window. The window includes at least two panes and a sash. The at least two panes include a first pane and a second pane, each of which is opposite and parallel to and spaced apart from the other. The first pane includes at least two layers of a durable transparent polymer film adhered to and covering a surface of the first pane that is facing the second pane, wherein the at least two layers are adhered in directions that are not parallel to one another. The second pane is free of the durable transparent polymer film, and the first and second panes are spaced apart and sealed to a spacer that is integral with the sash.

Among the several advantages found to be achieved by the present invention, therefore, may be noted the provision of an impact resistant multipane insulating window, the provision of such a window that is easy to fabricate and requires less labor during fabrication than conventional impact resistant double glazed windows, the provision of such a window that is lighter in weight and has a lower width requirement than conventional impact resistant double glazed windows and the provision of such a glass pane that can be easily shipped, stored or inventoried before it is utilized in an impact resistant multipane insulating window.

### BRIEF DESCRIPTION OF THE DRAWINGS

FIG. 1 is an illustration of a partial cross-section of an impact resistant window of the prior art showing panes (101 and 103) separated by an internal durable transparent polymer film (110);

FIG. 2 illustrates a partial cross-section of a multipane insulating window of the prior art showing panes (101 and 102) attached together by a spacer (220) to provide a gas space (201) between the two panes;

FIG. 3 illustrates a partial cross-section of an impact resistant multipane insulating window of the prior art showing a combination of the structures shown in FIG. 1 and FIG. 2, but in which the center pane (101′) acts both as one side of a multipane insulating window and one side of an impact resistant window;

FIG. 4 shows a particle cross-section of another embodiment of an impact resistant multipane insulating window of the prior art that is similar to the structure shown in FIG. 2, except that durable transparent polymer films (111 and 112) are adhered to the surface of the panes that is sealed to the spacer (220);

FIG. 5 illustrates a partial cross-section view of an embodiment of an impact resistant multipane insulating window of the present invention;

FIG. 6 illustrates a partial cross-section view of another embodiment of an impact resistant multipane insulating window of the present invention;

FIG. 7 shows (A) a front view, (B) a side view, and (C) a perspective view of an embodiment of an impact resistant multipane window of the present invention;

FIG. 8 shows a partial cross-section of an embodiment of an impact resistant multipane window of the present invention wherein the sash is a polymer extrusion having a metal stiffener and wherein the panes are sealed to the sealing surfaces of the integral spacer with glazing tape; optional snap-in glazing beads are omitted in this figure; and

FIG. 9 shows a partial cross-section of an embodiment of a glass pane (101) with a protective layer (121) on a durable transparent polymer film (111) in accordance with the present invention.

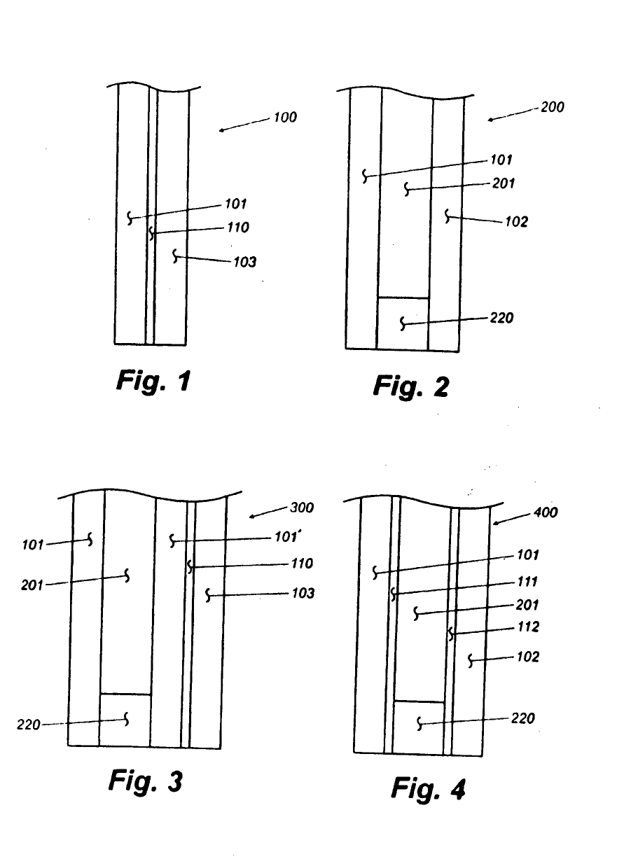

Corresponding reference characters indicate corresponding parts throughout the several views of the drawings.

### DETAILED DESCRIPTION OF THE PREFERRED EMBODIMENTS

In accordance with the present invention, it has been discovered that a novel double glazed impact resistant window can be produced by forming a window sash that delineates a mounting space for mounting a first pane and a second pane opposite and parallel to and spaced apart from each other, where the sash is formed from sash elements having an integral spacer that forms a sealing surface of the mounting space for each pane. One pane of the window either can be provided with a coating of a durable transparent polymer film on one side, or can be formed by adhering a durable transparent polymer film to a surface of the pane. The film can be applied to the pane either before or after it is conformed to the size required for the mounting space. The first pane is then mounted in the mounting space with the film-covered surface of the pane facing the sealing surface of the integral spacer, and the second pane, without a film covering, is then mounted in the mounting space to form a double glazed impact resistant window.

The present invention also includes an insulating multipane impact resistant window that comprises at least two panes and a sash, wherein the at least two panes comprise a first pane and a second pane each of which is opposite and parallel to and spaced apart from the other. The first pane includes a durable transparent polymer film adhered to and covering a surface of the pane that is facing the second pane, the second pane is free of the durable transparent polymer film, and the panes are spaced apart by and sealed to a spacer that is integral with the sash.

As used herein, the terms “free of the durable transparent polymer film” mean the referenced pane is not fully coated with the durable transparent polymer film. Stated differently, the referenced pane may have at least some portion that is coated with a durable transparent polymer film and/or has a durable transparent polymer film adhered thereto, but the referenced pane is not covered with a sufficient amount of film to impart impact resistance to the window system.

Unexpectedly, the inventors discovered that sufficient impact resistance in the insulating multi-pane window may be achieved by adhering and/or coating the durable transparent polymer film onto only the pane of glass that faces the exterior of a structure when the present window system is installed in a structure. As will be discussed in more detail below the durable transparent polymer film is preferably adhered to, or coated onto, the side of the first pane that faces the second pane in the window system. Without being bound by theory, the inventors believe that the impact resistance is achieved by adhering and/or coating at least two layers of the durable transparent polymer film onto the first pane in directions that are not parallel to one another, because such adherence or coating results in at least some cross-linking between the layers, providing enhanced impact resistance over films that are adhered or coated in only one layer and/or are adhered or coated in more than one layer, in which adjacent layers are parallel to one another. For example, the first layer may be adhered or coated in the machine direction (MD) and the second layer may be adhered or coated to the first layer in the transverse direction (TD). Alternatively, the first layer may be adhered or coated in the TD and the second layer may be adhered or coated in the MD.

The at least two layers of the durable polymer transparent film may be adhered or coated at any opposing angles to one another, so long as the at least two layers are not adhered or coated in directions parallel to one another.

Similarly, more than two layers may be adhered or coated to the first pane and to one another, so long as at least two of the layers are adhered or coated in directions that are not parallel to one another. For example, the first layer may be adhered or coated in the MD, the second layer may be adhered or coated in the TD, and a third layer may also be adhered or coated in the TD. In another embodiment, the first layer may be adhered or coated in the MD, the second layer may be adhered or coated in the MD, and a third layer may be adhered or coated in the TD. Those having ordinary skill in the art will recognize other configurations that fit within the above description, and such configurations are intended to be included in the present description.

As used herein, the terms “in directions that are not parallel to one another” means the layers are adhered or coated at angles to one another of between about 5° and about 175°. In some embodiments, the directions may be offset at angles between about 45° and about 135°, in other embodiments, between about 75° and about 105°. In some embodiments, the directions are at angles of about 90°.

In an embodiment of the invention, the sash can be formed from extruded PVC members having a spacer formed integrally with the body of the member. The parts of the sash, commonly the top and bottom rails and the left and right stiles, can then be cut and assembled from the PVC extrusion to form one or more mounting spaces for panes. Each mounting space is formed so that the integral spacer on each part of the sash surrounding the mounting space forms a part of the mounting space and provides mounting surfaces for each pane. Panes can be coated with the durable transparent polymer film anytime prior to assembly, and assembly can be completed by attaching double-sided glazing tape to the mounting surfaces and sealing the panes to the glazing tape. Snap-in glazing beads can be installed if desirable.

This assembly method is rapid, demands less labor than required for normal insulated double glazed windows, and provides a high quality product that is energy efficient and easy to install. Furthermore, when a polymer extrusion is used for the sash construction, the resulting window requires very little maintenance and is very resistant to environmental damage.

As used herein, the term “window” means a sash with one or more transparent or translucent glazing panes that can be used to cover any opening in a structure. Commonly, a window is installed in a window frame. The term window includes all windows, such as double-hung windows, bay windows, bow windows, casement windows, fixed windows, and the like; door panels having transparent or translucent glazing; wall panels having transparent or translucent glazing; and similar structures.

As used herein, the term “sash” means the framework that holds the glazing in a window.

As used herein, the terms “mounting space” mean the space in a sash into which a glazing pane is to be mounted. Commonly the mounting space is delineated by the parts, or elements, of the sash, which are cut to the proper size that when attached together form a mounting space of approximately the same shape and slightly larger size than the glazing pane that is to be mounted therein. The mounting space can be of any shape and size, including round, oval, oblong, rectangular, square, triangular, pie-shaped, or of any other shape. Commonly, the mounting space is square, rectangular, or round.

As used herein, the terms “sealing surface” mean that surface of the integral spacer of a sash against which the glazing pane is mounted. The sealing surface is commonly a flat surface of the spacer that is parallel to the plane of the glazing pane.

As used herein, the terms “integral spacer” mean a part of the sash that extends into the mounting space and which provides at least two sealing surfaces for mounting glazing panes opposite to and parallel to each other and spaced apart by a distance that is determined by the width of the integral spacer. The integral spacer is formed as an integral piece of the sash. When viewed in cross-section, the integral spacer can comprise one or more individual projections from the body of the sash and can be in two or more parts, can be hollow, partially hollow, or have a cross-section appropriate for production by extrusion, but in each case, the spacer is an integral part of the sash. When it is said that the integral spacer is an “integral part” of the sash, it is meant that the integral spacer is formed at the same time as and as a portion of the sash, such as during extrusion, and is not attached to the sash after formation of the sash elements.

Various embodiments of the present novel insulating multipane impact resistant window will now be described with reference to the figures.

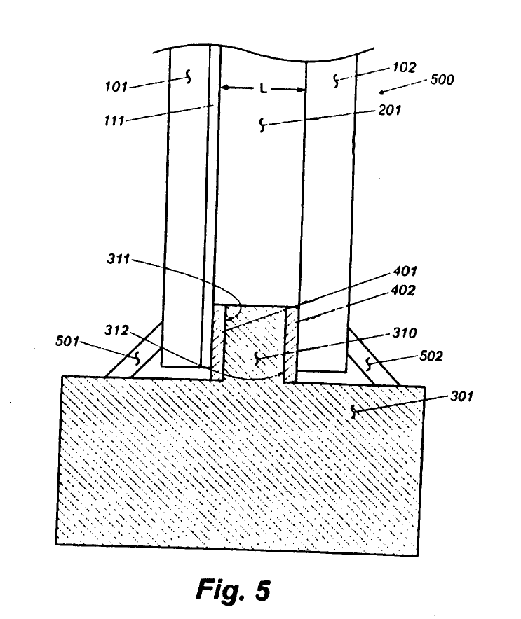

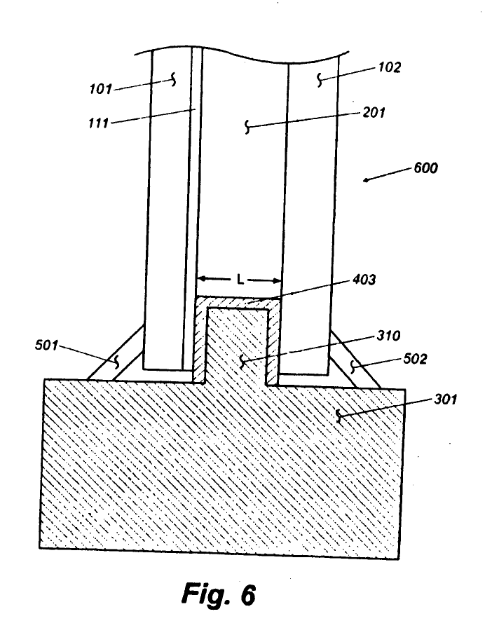

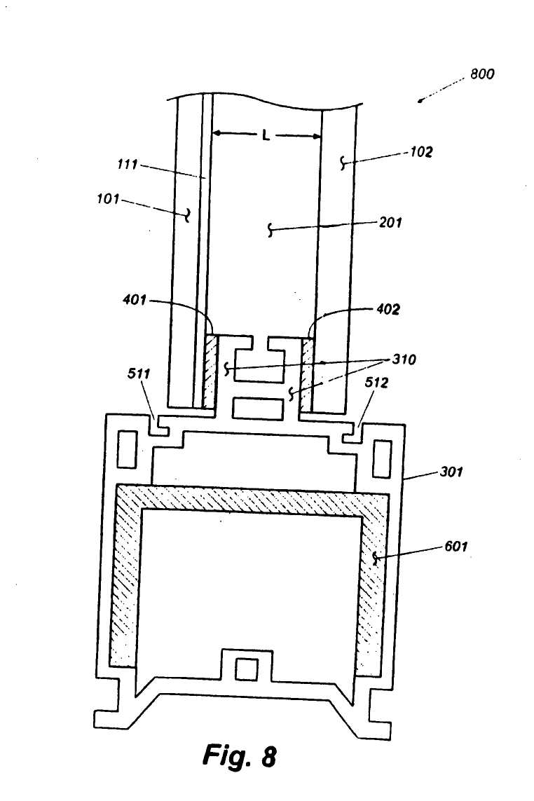

FIG. 5, FIG. 6 and FIG. 8 show partial cross-sectional views of embodiments of a double glazed impact resistant window of the present invention in which the sash (301) has an integral spacer (310) projecting therefrom. The integral spacer (310) provides a first sealing surface (311) and a second sealing surface (312), for mounting glazing panes opposite to and parallel to each other and spaced apart by a distance that is determined by the width of the integral spacer. The glazing panes comprise a first glazing pane (101) and a second glazing pane (102), the first glazing pane (101) having a durable transparent polymer film (111) attached to the surface of the pane that faces the second pane. Each embodiment shown in FIG. 5 and FIG. 6 show glazing beads (501, 502) that optionally can be used to further seal the glazing panes onto the sash. In FIG. 8, the optional glazing beads are omitted. The optional glazing beads (501 and 502) can be pre-formed plastic snap-in type glazing beads, particularly when the sash (301) is an extruded member as shown in FIG. 8, or they can be formed from a silicone, butyl, or other sealant material, or both a snap-in glazing bead and a polymeric-type sealant can be used if desirable to form a hermetic seal for the enclosed space (201) and/or to more securely seal the pane into the sash. The first pane (101) and the second pane (102) are attached to the sealing surfaces (311 and 312) of the integral spacer (310) by a first sealant (401) and a second sealant (402), or, as shown in FIG. 6, by a sealant (403) that is unitary: enclosing the spacer and forming sealing surfaces for both panes.

FIG. 5, FIG. 6 and FIG. 8 show an enclosed space (201) that is bounded by the spacer that is integral with the sash, the first pane, and the second pane. In some embodiments, the enclosed space can be hermetically sealed from the surrounding atmosphere, and if desired, it can be filled with a gas, such as dry air, or with an inert gas such as argon or nitrogen. In some embodiments, it is useful to provide a desiccant, such as sodium silicate, for example, (not shown in the figures) that is in communication with the enclosed space and is useful to absorb any moisture that may enter the enclosed space in order to avoid or reduce condensation.

The glazing panes that are useful in the present invention can each separately comprise a material selected from the group consisting of glass, fiberglass and plastic. If plastic is used, it can be a polycarbonate, a polyurethane, lexan, Plexiglas, or the like. In some embodiments, it is preferred that the first pane and the second pane each comprise glass. The glass can be annealed glass, tempered glass, or untempered glass. Due to reduced cost, in some embodiments untempered glass is preferred for the glazing panes.

FIG. 5, FIG. 6 and FIG. 8 each show the first pane (101) and the second pane (102), the first pane (101) having a durable transparent polymer film (111) attached to the surface of the pane that faces the second pane.

The durable transparent polymer film that is useful in the present invention can comprise any polymer, including polyamides, such as nylon; polyolefins such as polypropylene and polyethylene; polyester such as polyethylene terephthalate, polyethylene naphthalate, and polybutylene terephthalate; polyacetal; polycarbonate; copolyesters such as polyethylene terephthalate isophthalate; and the like.

It is preferred that the durable transparent polymer film is at least translucent to visible light and is preferred to be transparent. In particular, it is preferred that the polymer film have a percent transmission of visible light of at least about 30%, at least about 40% is more preferred, at least about 50% is yet more preferred, at least about 60% is even more preferred, at least about 70% is yet more preferred, at least about 80% is even more preferred, and a visible light transmission of at least about 82% is yet more preferred.

The polymer film should also be durable. When it is said that the polymer film is durable, it is meant that the polymer is one that has a tensile strength of at least about 15,000 psi, at least about 20,000 psi is more preferred, at least about 25,000 psi is even more preferred, and at least about 30,000 psi is yet more preferred.

It is also preferred that the polymer film is one that has a break strength of at least about 50 lbs/in, and at least about 100 lbs/in is even more preferred, at least about 150 lbs/in is yet more preferred, and at least about 200 lbs/in is even more preferred.

The polymer film can be single thickness, or it can be laminated. Laminated films of this type are described, for example, in U.S. Pat. No. 6,951,595. Films suitable for the present invention are available commercially from Madico, Inc., Woburn, Mass.; 3M, Minneapolis, Minn., and Mitsubishi Polyester Film, LLC, among others.

The durable transparent polymer film of the present invention normally has a uniform thickness, which can be any thickness that is sufficient to provide the features required. Films that are useful in the present invention normally have a thickness within a range of about 0.25 mil to about 50 mil. A thickness from about 5 mil to about 30 mil is preferred, a thickness of from about 10 mil to about 20 mil is more preferred, and a thickness of about 12 mil to about 15 mil is even more preferred.

It is useful for the durable transparent polymer film to be supplied with, or to be prepared to have, a pressure sensitive adhesive on one side that is suitable for adhering the film to the pane. In particular, it is useful for the film to have a pressure sensitive adhesive suitable for forming a tight bond with a clean glass surface.

The present polymer film can be provided with a hard coat, such as is described in U.S. Pat. No. 7,101,616, for example, or without such a hard coat. In fact, an advantage of the present invention is that by locating the durable polymer film on the protected interior surface of the panes, in other words, on the surface of the first pane that faces the second pane and that seals against the integral spacer of the sash, the free surface of each film is protected from any touch and retains its clear, unmarred visual qualities without the expense of applying a hard coat.

In the present window, the first pane (101) and the second pane (102) are spaced apart by a certain distance. This is shown in FIG. 5, FIG. 6, and FIG. 8 as being the distance (I). The distance between the panes is determined by the distance between the sealing surfaces (311 and 312) of the integral spacer (310), plus the thickness of the sealant (401 and 402) that is used to adhere the panes to the integral spacer. Although the panes can be spaced apart by any distance that will provide the advantages of the invention, it is preferred that the first pane and the second pane are spaced apart by a distance of from about 1 mm to about 20 mm, a distance of from about 6 mm to about 16 mm is more preferred, and a distance of from about 6 mm to about 12 mm is even more preferred.

In the present window, the sash can be composed of any material that is conventionally used for the construction of window sashes. In an embodiment of the present window, the sash comprises a material that is selected from one or more of the group consisting of wood, metal and plastic.

It has been found to be particularly useful for the sash to be formed from polymer extrusions. This type of sash construction is known in the art and an example is shown in FIG. 8. Examples of extruded sash material are shown in U.S. Pat. Nos. 5,622,017 and 6,286,288, among others. Various types of extruded window and door sash material is available from Chelsea Building Products, Oakmont, Pa., and other manufacturers.

Extruded sashes can be produced from any polymer, copolymer, or polymer blend that is suitable to provide the advantages of the invention. The polymer can be filled or unfilled. Examples of materials that are suitable for the production of polymer sash extrusions include polyvinyl chloride, polycarbonate, polyvinyl, and Extrudable Thermal Plastics available from Geon division of the B. F. Goodrich Co., as well as the materials described in U.S. Pat. Nos. 4,430,478 and 5,783,620, among others.

When the sash material is a polymer extrusion, it is optional to include a metal stiffener (601) as shown in FIG. 8. Such stiffeners are sometimes used when a long sash length is required, or when exceptionally heavy glass must be supported. One or more metal stiffeners can be used in a window sash.

FIG. 8 illustrates the use of an extruded sash (301) in the present invention, and shows the inclusion of an optional metal stiffener (601). The extruded sash (301) includes an integral spacer (310) having two sealing surfaces against which the first pane (101) and the second pane (102) are sealed. The distance between the sealing surface for the first pane and the sealing surface for the second pane determines the distance by which the first pane and the second pane are spaced apart. The panes each have a durable transparent polymer film (111 and 112) adhered to the surface of the pane that faces the other pane. Snap-in glazing beads are optionally useful for this embodiment and could be attached into snap-in glazing bead slots (511 and 512), such glazing beads are not shown in FIG. 8.

FIG. 5, FIG. 6 and FIG. 8 indicate that the first pane (101) and the second pane (102) are sealed to the sealing surfaces (311 and 312) of the spacer (310) by the use of a sealant (401 and 402, or 403). The sealant can be any material or device that is used to seal glazing panes to a window sash, and can be selected from glazing tape, silicone sealant, butyl sealant, or a combination of any two or more of these techniques. In an embodiment of the present invention, it is particularly useful to use glazing tape as the sealant.

The use of glazing tape is well known in the art to seal panes, in particular glass panes, into window sashes. Glazing tape is typically a polymer tape having pressure sensitive adhesive on both sides. Some glazing tapes are formed from closed cell polyolefin foam with a glass adhesive on one side and a sash/frame adhesive on the other. See, e.g., Glazing Tape VG 100, or VG-300, available from Venture Tape, Rockland, Mass. Glazing tape suitable for use in the present application is also available from Lamatek, Inc., West Deptford, N.J., and Press-On Tape and Gasket Corp., Addison, Ill.

If desired, optional glazing beads 501 and 502 can be used to finish the glazing. When the sash comprises a polymer extrusion, the glazing bead can be snap-in glazing bead.

When the present window is assembled, the panes (102 and 103) and the spacer (310) provide an enclosed space (201) that serves as an insulating feature of the window. In some embodiments, the enclosed space (201) is hermetically sealed from the outside environment, and if desired, the gas in the enclosed space can be dry air, or can be an inert gas, such as argon or nitrogen.

In order to minimize the moisture content of the gas in the enclosed space, a desiccant is optionally provided that is in contact with the enclosed space. The desiccant can be placed into an aperture of an extruded sash, if desired, so that it communicates with the gas in the enclosed space.

The present invention encompasses a method of making a double glazed impact resistant window. The method comprises forming a window sash that delineates a mounting space for mounting a first pane and a second pane opposite and parallel to and spaced apart from each other, the sash having an integral spacer that forms a sealing surface of the mounting space for each pane. The mounting space is typically formed by constructing a frame of sash members, often pieces cut to length from a long extrusion or molding, as described above, where the frame encloses a space that is slightly larger than and approximately the same shape as the pane that is to be mounted therein. The mounting space is bounded on each side by the sash (301) and on the surface to which the pane is to be mounted by the sealing surface (311 or 312) of the integral spacer (310). The mounting space is sized so that the pane (101 or 102) will fit therein without touching any side of the mounting space, but will rest on all parts of the respective sealing surface (311 or 312). The spacing of the pane (101 or 102) from the sash (301) is shown in FIGS. 5, 6 and 8, and is useful to permit differential expansion of the sash and the pane without causing contact between the pane and the sash, other than at the sealing surface (311 or 312).

At any time during the fabrication process, the durable transparent polymer film (111) is adhered to a surface of the first pane (101). The film can be adhered to a large piece of glass, and then the panes, with film attached, can be cut from the larger sheet to conform to the size and shape of the mounting space, or alternatively, the film can be adhered to the pane after the larger sheet has been cut to conform to a suitable size.

The polymer film is commonly adhered to the panes by the use of a pressure sensitive adhesive that coats one side of the film and adheres tightly to the pane. When the film is obtained from a supplier, it optionally already has the adhesive applied to one side of the film, and provides a protective film, often silicone, over the adhesive. The protective film can be removed and the film can be adhered to the pane.

When the panes are glass, it is preferred that the glass is very clean before the durable transparent polymer film is attached. Any small particle that is present on the glass when the film is applied will remain in the assembly forever, and can have a negative effect on the strength of adherence of the film to the glass (which may negatively affect the impact resistance of the window) and on the visual quality of the window. Accordingly, it is preferred that the glass is thoroughly cleaned prior to applying the film and that the assembly of the film to the glass be carried out in a clean atmosphere.

In some embodiments, excess durable transparent polymer film may be present around the edges of the pane after the durable transparent polymer film has been adhered. In these embodiments, the method further includes trimming the excess durable transparent polymer film prior to the mounting step. The trimming can be done by any method known in the art. For example, in some embodiments, the trimming may be done with a blade, such as a knife or box cutter. In other embodiments, the trimming may be done with a laser.

In further embodiments where the method includes trimming, the trimming of the excess durable transparent polymer film may be done such that the durable transparent polymer film edge is flush with the edge of either glass pane. In other embodiments where trimming is utilized, an amount of durable transparent polymer film may remain over the edge of the glass pane. In further embodiments where trimming is utilized, the trimming of the durable transparent polymer film may be done such that the film no longer covers the entire glass pane.

If trimming of the durable transparent polymer film is utilized, it may be done at any stage of the presently claimed method. In some embodiments, the trimming may be done before the protective layer is provided. In other embodiments, the trimming may be done after the protective layer is provided. In other embodiments, the trimming may be done before mounting the pane in the mounting space. In further embodiments, the trimming may be done after mounting the pane in the mounting space.

When film-coated panes of the proper size are prepared, the first pane (101) is mounted in the mounting space with the film-covered surface of the pane facing the sealing surface (311) of the integral spacer (310).

In some embodiments it is preferred to use glazing tape as the sealant in order to prevent or minimize the amount of “squeeze up” of the sealant into the viewing area of the mounting space. Because the enclosed space (201) is essentially sealed as soon as both panes are mounted in the sash, any sealant that is squeezed up between the pane and the sealing surface into the viewing area of the mounting space cannot be removed. However, the use of glazing tape substantially prevents such squeeze up, but provides a strong and durable bond between the pane and the sash. When glazing tape is used as the sealant (401 and 402, or 403), the step of mounting the pane in the sash involves adhering glazing tape to the sealing surface of the mounting space and contacting each pane with the tape so that the film-covered surface of the pane is facing the tape. In some embodiments, it is useful to supplement glazing tape with a deformable type sealant, such as a silicone sealant, in order to improve the integrity of the seal.

Glazing beads (501 and 502) can optionally be added to the window to finish the assembly if desired.

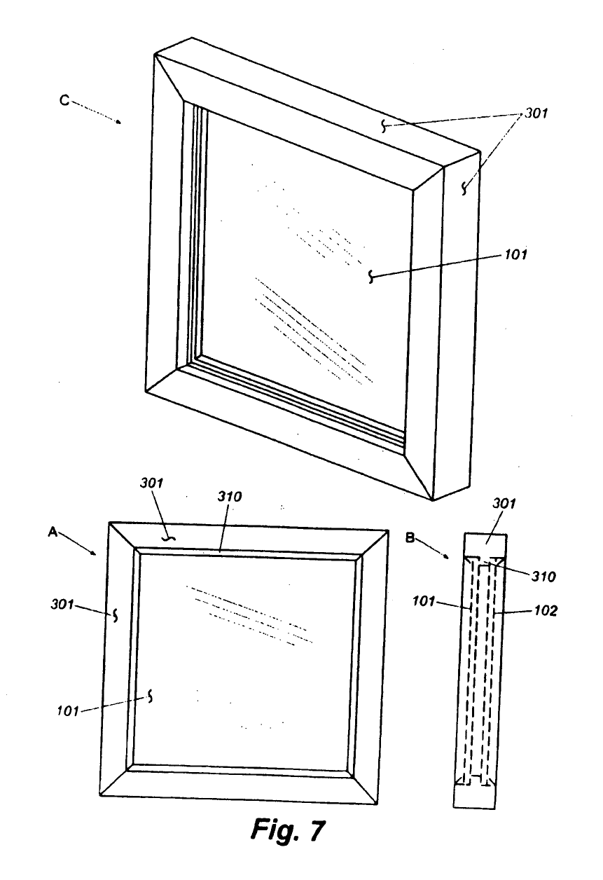

A typical embodiment of a window of the present invention is shown in FIG. 7, where view (A) shows a front view, (B) shows a right side view, and (C) shows a perspective view of a window having sashes (301) with integral spacers (310) that have been assembled to form a frame that defines a mounting space, into which panes (101 and 102) are mounted to form an impact resistant multipane window.

The impact resistant multipane windows of the present invention can be mounted and used in any application in which conventional impact resistant and/or multipane windows are used. Commonly, the novel windows can be mounted in frames in structures such as residential or commercial buildings to serve as strong, energy conserving windows. The novel windows can be components of doors, panels, skylights, and any other similar application. Mounting and use of the present windows is similar to the methods that are well known and are used for conventional impact resistant and/or multipane windows.

The present invention encompasses a further method of making a double glazed impact resistant window. The method comprises, in some embodiments, forming a window sash that delineates a mounting space for mounting a first pane and a second pane opposite and parallel to and spaced apart from each other, the sash having an integral spacer that forms a sealing surface of the mounting space for each pane; adhering a durable transparent polymer film to a surface of the first pane; attaching a protective layer to at least a portion of the durable transparent polymer film to protect the durable transparent polymer film from damage prior to assembling the double glazed impact resistant window; conforming the pane to the size and shape of the mounting space; removing the protective layer; mounting the first pane in the mounting space with the film covered surface of the pane facing the sealing surface of the integral spacer; conforming the second pane to the size and shape of the mounting space, wherein the second pane is free of the durable transparent polymer film, and mounting the second pane in the mounting space.

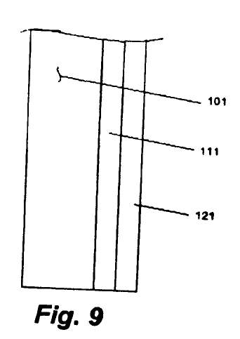

FIG. 9 shows a partial cross-sectional view of embodiments of a glass pane (101) with a durable transparent polymer film (111) and a protective layer (121) in accordance with the present invention. In some embodiments, the protective layer is used to protect the durable transparent polymer film. In such embodiments, the protective layer may be used to protect the durable transparent polymer film on the glass panes before they are installed into a double glazed impact resistant window. The protection provided by the protective layer may aid, for example, in storing, inventorying, and for shipping the film covered glass pane.

In some embodiments, the method may be carried out in such a way that the protective layer is removed after mounting the first pane in the mounting space. Optionally, the method may be carried out in such a way that the protective layer is removed at any other appropriate time.

The protective layer can be composed of any polymer material known in the art that will protect the durable transparent polymer film from damage. A polymer is used as a protective layer for a number of reasons including resistance to humidity, durability, and ability to provide a smooth surface with which to effectively cover the durable transparent polymer film. A smooth surface is desirable to ensure that the protective layer and the durable transparent polymer film properly bond together so that no contaminants dirty the durable transparent polymer film. Many of the areas where the glass panes will be shipped are areas that are at high risk for storms. This creates a need for a protective layer having a high resistance to humidity. Additionally, a durable protective layer is useful in order to avoid marring the glass panes or the durable transparent polymer film while the items are being shipped, inventoried, and stored.

In some embodiments the polymer that is used for the protective layer is selected from the group consisting of polyethylene, polypropylene, polyester, ABS, cellulose triacetate, epoxy, polyacrylamide, polyacrylate, polyamide, polyamideimide, polybutylene terephthalate, polycarbonate, polyethylene terephthalate, polyimide, polymethyl (meth)acrylate, polyolefin, polystyrene, polyurethane, polyvinyl, polyvinyl alcohol, polyvinyl chloride, vinyl acetate, and combinations thereof. The polymer selected may be polyester, and in some situations may be MYLAR® or MYLAR® derivatives. In further embodiments, the protective layer comprises polyethylene.

The protective layer may be of any thickness necessary to perform its desired function. The thickness of the protective layer may be between about 0.1 mils and about 8 mils. Optionally, the thickness of the protective layer may be between about 0.5 mils and about 3 mils or may be about 2 mils.

The protective layer may be composed of one layer or multiple layers. In some embodiments of the invention, the protective layer is composed of two, three, four, or five layers. In other embodiments, the protective layer is composed of about one layer.

The protective layer may be applied to the surface of the durable transparent polymer film in any way known in the art. In some embodiments, the protective layer may be applied to the surface of the durable transparent polymer film by a non-transferring adhesive. For example, the adhesive may be AROSET®, AROMELT® or AROCURE™ from Ashland, ADCOTE® or SERFENE® from Rohm and Haas, or other non-transferring adhesives known in the art.

In other embodiments, the protective layer may be adhered to the surface of the durable transparent polymer film by the use of a static charge. In embodiments such as these, the protective layer may be applied and removed without leaving any residue on or causing any damage to the durable transparent polymer film. Such results may be beneficial due to the need to maintain relative transparency of the glass pane and the durable transparent polymer coating.

The protective layer may be removed by any process known in the art. The removal process of the protective layer, however, should not remove the durable transparent polymer film which it is used to protect. In some embodiments of the invention the protective layer may be removed by heat treatment, washing with an acid, washing with a base, washing with water, removal by hand, removal with a blade and combinations thereof. In other embodiments, the protective layer may be removed by hand. If the protective layer may be removed by hand, in some embodiments, the protective layer may contain a pull tab.

Other embodiments within the scope of the claims herein will be apparent to one skilled in the art from consideration of the specification or practice of the invention as disclosed herein. It is intended that the specification be considered to be exemplary only, with the scope and spirit of the invention being indicated by the claims.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description and shown in the accompanying drawings shall be interpreted as illustrative and not in a limiting sense. In addition it should be understood that aspects of the various embodiments may be interchanged both in whole or in part.

What is claimed is:

1. A method of making a double glazed impact resistant window, the method comprising:
forming a window sash that delineates a mounting space for mounting a first pane and a second pane opposite and parallel to and spaced apart from each other, the sash having an integral spacer that forms a sealing surface of the mounting space for each pane;
adhering or coating at least two layers of a durable transparent polymer film to a surface of the first pane such that the at least two layers are not adhered or coated in directions that are parallel to one another;
conforming the first pane to the size and shape of the mounting space;
mounting the first pane in the mounting space with the film covered surface of the pane facing the sealing surface of the integral spacer;
confirming the second pane to the size and shape of the mounting space, wherein the second pane is free of a durable transparent polymer film; and
mounting the second pane in the mounting space.

2. The method according to claim 1, wherein the first pane, the second pane and the sash comprise an enclosed space.

3. The method according to claim 1, wherein the first pane and the second pane each comprise glass.

4. The method according to claim 1, wherein the step of forming a window sash comprises attaching sash elements to each other to form a frame that delineates a mounting space for mounting a first pane and a second pane opposite and parallel to and spaced apart from each other, wherein each part of the sash frame has an integral spacer that together with the integral spacer of other parts of the sash frame forms a sealing surface of the mounting space for each pane; and wherein the sash comprises a material that is selected from one or more of the group consisting of wood, metal and plastic.

5. The method according to claim 1, further comprising attaching a protective layer to at least a portion of the durable transparent polymer film to protect the durable transparent polymer film from damage prior to assembling the double glazed impact resistance window.

6. The method according to claim 5, wherein the protective layer is selected from the group of polyethylene, polypropylene, polyester, ABS, cellulose triacetate, epoxy, polyacrylamide, polyacrylate, polyamide, polyamideimide, polybutylene terephthalate, polycarbonate, polyethylene terephthalate, polyimide, polymethyl (meth)acrylate, polyolefin, polystyrene, polyurethane, polyvinyl, polyvinyl alcohol, polyvinyl chloride, vinyl acetate, and combinations thereof.

7. The method according to claim 5, wherein the protective layer has a thickness between about 0.1 mils and about 8 mils.

8. The method according to claim 5, further comprising removing the protective layer.

9. The method according to claim 8, wherein the step of removing the protective layer is conducted prior to the step of mounting the first pane.

10. The method according to claim 8, wherein the protective layer can be removed by any process selected from the group of heat treatment, washing with an acid, washing with a base, washing with water, removal by hand, and combinations thereof.

11. The method according to claim 5, further comprising trimming the durable transparent polymer film prior to the step of mounting the first pane.

12. The method according to claim 11, wherein the trimming is done prior to the step of attaching a protective layer.

13. The method according to claim 1, wherein mounting comprises:
a) adhering glazing tape to the sealing surface of the mounting space; and
b) contacting each pane with the tape so that the film-covered surface of the pane is facing the tape.

14. The method according to claim 4, wherein the step of mounting the first pane in the mounting space with the film-covered surface of the pane facing the sealing surface of the integral spacer comprises adhering the pane to the sealing surface with a sealant.

15. The method according to claim 14, wherein the sealant comprises glazing tape.

16. The method according to claim 1, wherein the first pane and second pane are spaced apart by a distance of from about 6 mm to about 12 mm.

17. The method according to claim 1, further comprising installing a glazing bead around each of the first pane and the second pane.

18. A method of making a double glazed impact resistant window, the method comprising:
forming a window sash that delineates a mounting space for mounting a first pane and a second pane opposite and parallel to and spaced apart from each other, the sash having an integral spacer that forms a sealing surface of the mounting space for each pane;
adhering or coating at least two layers of a durable transparent polymer film to a surface of the first pane such that the at least two layers are adhered or coated in directions that are not parallel to one another;
conforming the first pane to the size and shape of the mounting space;
trimming the durable transparent polymer film;
mounting the first pane in the mounting space with the film covered surface of the pane facing the sealing surface of the integral spacer;
conforming the second pane to the size and shape of the mounting space, wherein the second pane is free of the durable transparent film; and
mounting the second pane in the mounting space.

19. The method according to claim 18, wherein the durable transparent polymer film is free of a hard coat.

20. The method according to claim 18, wherein the trimming is done prior to the step of mounting the first pane.

21. The method according to claim 18, further comprising:
attaching a protective layer to at least a portion of the durable transparent polymer film to protect the durable transparent polymer film from damage after the step of adhering a durable transparent film to a surface of the first pane; and
removing the protective layer after the step of conforming the pane to the size and shape of the mounting space.

22. The method according to claim 21, wherein the protective layer is selected from the group of polyethylene, polypropylene, polyester, ABS, cellulose triacetate, epoxy, polyacrylamide, polyacrylate, polyamide, polyamideimide, polybutylene terephthalate, polycarbonate, polyethylene terephthalate, polyimide, polymethyl (meth)acrylate, polyolefin, polystyrene, polyurethane, polyvinyl, polyvinyl alcohol, polyvinyl chloride, vinyl acetate, and combinations thereof.

23. The method according to claim 21, wherein the protective layer has a thickness between about 0.1 and about 8 mils.

24. The method according to claim 21, wherein the step of removing the protective layer is conducted prior to the step of mounting the first pane.

25. The method according to claim 21, wherein the protective layer can be removed by any process selected from the group of heat treatment, washing with an acid, washing with a base, washing with water, removal by hand, removal with a blade, and combinations thereof.

26. An insulating multipane impact resistant window comprising:
at least two panes and a sash, wherein the at least two panes comprise:
a first pane and a second pane each of which is opposite and parallel to and spaced apart from the other, wherein the first pane includes at least two layers of a durable transparent polymer film adhered to and covering a surface of the first pane that is facing the second pane, wherein the at least two layers are adhered in directions that are not parallel to one another, the second pane is free of the durable transparent polymer film, and wherein the first and second panes are spaced apart by and sealed to
a spacer that is integral with the sash.

27. The window according to claim 26, comprising an enclosed space that is bounded by the spacer that is integral with the sash, the first pane, and the second pane.

28. The window according to claim 26, wherein the first pane and the second pane each comprise glass.

29. The window according to claim 28, wherein the glass comprises untempered glass.

30. The window according to claim 26, wherein the durable transparent polymer film comprises a laminated film.

31. The window according to claim 26, wherein the durable transparent polymer film has a thickness of from about 10 mil to about 20 mil.

32. The window according to claim 26, wherein the first pane and the second pane are spaced apart by a distance of from about 1 mm to about 20 mm.

33. The window according to claim 26, wherein the sash comprises polymer extrusions each of which has an integral spacer which comprises a sealing surface for the first pane and a sealing surface for the second pane, wherein the distance between the sealing surface for the first pane and the sealing surface for the second pane determines the distance by which the first pane and the second pane are spaced apart.

34. The window according to claim 26, wherein the first pane and the second pane are sealed to the integral spacer by glazing tape.

35. The window according to claim 26, further comprising a glazing bead and wherein the sash comprises a polymer extrusion and the glazing bead comprises a snap-in glazing bead.

36. The window according to claim 27, wherein the enclosed space is hermetically sealed and is in contact with a desiccant.
